(19) United States
(12) Patent Application Publication
(10) Pub. No.: US 2022/0252544 A1
(43) Pub. Date: Aug. 11, 2022

(54) FINE PARTICLE MEASURING SYSTEM

(71) Applicant: ADVANTEST CORPORATION, Tokyo (JP)

(72) Inventors: Hiroshi SATO, Tokyo (JP); Nobuei WASHIZU, Tokyo (JP)

(21) Appl. No.: 17/732,833

(22) Filed: Apr. 29, 2022

Related U.S. Application Data
(63) Continuation of application No. PCT/JP2021/002586, filed on Jan. 26, 2021.

(30) Foreign Application Priority Data
Mar. 26, 2020 (JP) 2020-056582

(51) Int. Cl. G01N 27/447

(52) U.S. Cl. CPC G01N 27/44791; G01N 27/4473

(57) ABSTRACT

A nanopore device includes a pore and an electrode pair. A current measurement unit applies a bias voltage that corresponds to a voltage setting command across an electrode pair and generates digital current data that corresponds to a current signal that flows through the nanopore device. A data processing apparatus generates the voltage setting command, acquires the current data and voltage data including information with respect to the waveform of the bias voltage Vb in a form in which they are associated on the time axis, and judges the kind of particles stored in the nanopore device based on the current data and the voltage data.

### CROSS REFERENCE TO RELATED APPLICATIONS

This application is a continuation under 35 U.S.C. § 120 of PCT/JP2021/002586, filed Jan. 26, 2021, which is incorporated herein by reference, and which claimed priority to Japanese Application No. 2020-056583, filed Mar. 26, 2020. The present application likewise claims priority under 35 U.S.C. § 119 to Japanese Application No. 2020-056583, filed Mar. 26, 2020, the entire content of which is also incorporated herein by reference.

### BACKGROUND

### 1. Technical Field

The present disclosure relates to measurement employing a nanopore device.

### 2. Description of the Related Art

A particle size distribution measurement method, which is referred to as the “electrical sensing zone method (the Coulter principle)”, is known. With this measurement method, an electrolyte solution including particles is applied such that it passes through a pore that is referred to as a “nanopore”. When a particle passes through such a pore, the amount of the electrolyte solution with which the pore is filled is reduced by an amount that corresponds to the volume of the particle, which raises the electrical resistance of the pore. Accordingly, in a case in which the pore has a thickness that is larger than the particle size, by measuring the electrical resistance of the pore, this arrangement is capable of measuring the volume of the particle that passes through the pore. Conversely, in a case in which the pore has a thickness that is sufficiently smaller than the particle size, this arrangement is capable of measuring the cross-sectional area (i.e., particle diameter) of the particle that passes through the pore.

FIG. 1 is a block diagram showing a microparticle measurement system 1R employing the electrical sensing zone method. The microparticle measurement system 1R includes a nanopore device 100, a measurement apparatus 200, and a data processing apparatus 300.

The internal space of the nanopore device 100 is filled with an electrolyte solution 2 including particles 4 to be detected. The internal space of the nanopore device 100 is divided by a nanopore chip 102 so as to define two internal spaces. Electrodes 106 and 108 are provided to the two spaces. When an electric potential difference is generated across the electrodes 106 and 108, this generates a flow of ion current across the electrodes. Furthermore, the particles 4 migrate by electrophoresis from a given space to the other space via the pore 104.

The measurement apparatus 200 generates the electric potential difference across the electrode pair 106 and 108 and generates information having a correlation with the resistance value Rp across the electrode pair. The measurement apparatus 200 includes a transimpedance amplifier 210, a voltage source 220, and a digitizer 230. The voltage source 220 generates an electric potential difference Vb across the electrode pair 106 and 108. The electric potential difference Vb functions as a driving source of the electrophoresis and is used as a bias signal for measuring the resistance value Rp.

A microscopic current Is flows across the electrode pair 106 and 108 in inverse proportion to the resistance of the pore 104.

Is=Vb/Rp (1)

The transimpedance amplifier 210 converts the microscopic current Is into a voltage signal Vs. With the conversion gain as r, the following expression holds true.

Vs=r×Is (2)

By substituting Expression (1) into Expression (2), the following Expression (3) is obtained.

Vs=Vb×r/Rp (3)

The digitizer 230 converts the voltage signal Vs into digital data Ds. As described above, the measurement apparatus 200 is capable of acquiring the voltage signal Vs in inverse proportion to the resistance value Rp of the pore 104.

FIG. 2 is a waveform diagram of an example of the microscopic current Is measured by the measurement apparatus 200. It should be noted that the vertical axis and the horizontal axis shown in the waveform diagrams and the time charts in the present specification are expanded or reduced as appropriate for ease of understanding. Also, each waveform shown in the drawing is simplified or exaggerated for emphasis or ease of understanding.

During a short period of time in which a particle passes through the pore 104, the resistance value Rp of the pore 104 becomes large. Accordingly, the current Is drops in the form of a pulse every time a particle passes through the pore 104. The change in the current Is has a correlation with the particle size. The data processing apparatus 300 processes the digital data Ds so as to analyze the number of the particles 4 contained in the electrolyte solution 2, the particle size distribution thereof, or the like.

### SUMMARY

The present disclosure has been made in view of such a situation.

An embodiment of the present disclosure relates to a microparticle measurement system. The microparticle measurement system includes: a nanopore device including a pore and an electrode pair; a current measurement unit structured to apply a bias voltage that corresponds to a voltage setting signal across the electrode pair, and to generate digital current data that corresponds to a current signal that flows through the nanopore device; and a data processing apparatus structured to generate a voltage setting command, to acquire the current data and voltage data including information with respect to the waveform of the bias voltage in a form in which they are associated on a time axis, and to judge the kind of a particle stored in the nanopore device based on the current data and the voltage data.

Another embodiment of the present disclosure relates to a measurement apparatus. In measurement, the measurement apparatus is coupled to a data processing apparatus and a nanopore device including a pore and an electrode pair. The measurement apparatus includes: a voltage source structured to apply a bias voltage across the electrode pair of the nanopore device; a transimpedance amplifier structured to detect a current that flows through the electrode pair of the nanopore device in measurement; an A/D conversion block structured to convert an output signal of the transimpedance amplifier into digital current data; and a bus controller coupled to the data processing apparatus, and structured to control the voltage source and the A/D conversion block based on a control command received from the data processing apparatus, and to transmit the current data and the voltage data that indicates the bias voltage applied across the electrode pair to the data processing apparatus in a format that allows them to be associated on a time axis.

It should be noted that any combination of the components described above, or any components or any manifestation of the present disclosure, may be mutually substituted between a method, apparatus, and so forth, which are also effective as an embodiment of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing a microparticle measurement system using an electrical sensing zone method,

FIG. 2 is a waveform diagram showing an example of a microscopic current Is measured by a measurement apparatus,

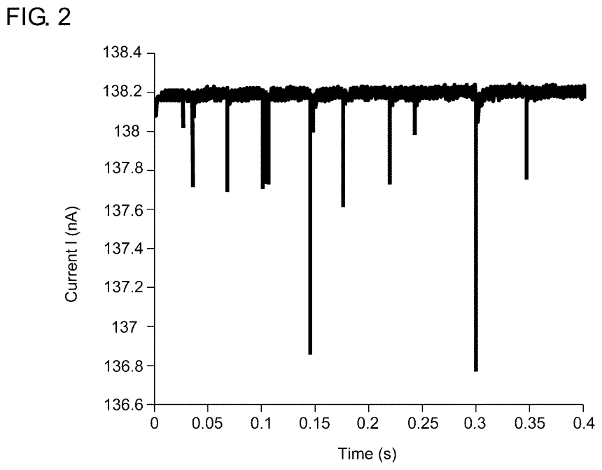

FIG. 3 is a block diagram showing a microparticle measurement system according to an embodiment,

FIG. 4 is a time chart showing the operation of the microparticle measurement system; and

FIG. 5 is a diagram showing an example of current data measured when the polarity of the bias voltage Vb is changed.

### DETAILED DESCRIPTION

### Outline of Embodiments

Description will be made regarding the outline of several exemplary embodiments of the present disclosure. The outline is a simplified explanation regarding several concepts of one or multiple embodiments as a prelude to the detailed description described later in order to provide a basic understanding of the embodiments. That is to say, the outline described below is by no means intended to restrict the scope of the present invention or the present disclosure. Furthermore, the outline described below is by no means a comprehensive outline of all the possible embodiments. That is to say, the outline described below by no means restricts essential components of the embodiments. For convenience, in some cases, an “embodiment” as used in the present specification represents a single or multiple embodiments disclosed in the present specification.

A microparticle measurement system according to an embodiment includes: a nanopore device including a pore and an electrode pair; a current measurement unit structured to apply a bias voltage that corresponds to a voltage setting signal across the electrode pair, and to generate digital current data that corresponds to a current signal that flows through the nanopore device; and a data processing apparatus structured to generate a voltage setting command, to acquire the current data and voltage data including information with respect to the waveform of the bias voltage in a form in which they are associated on a time axis, and to judge the kind of a particle stored in the nanopore device based on the current data and the voltage data.

In an embodiment, the voltage data may be generated at the same rate as a sampling rate of the current data.

In an embodiment, the voltage data may be generated every time a voltage application condition of the bias voltage is changed.

In an embodiment, the current measurement unit may include a voltage source structured to generate the bias voltage that corresponds to a voltage control signal. Also, the voltage data may be generated every time the state of the voltage source is switched.

In an embodiment, the voltage data may be generated every time the data processing apparatus issues the voltage setting command.

In an embodiment, the bias voltage may have a variable voltage level. Also, the voltage data may include information with respect to the voltage level of the bias voltage.

In an embodiment, the bias voltage may have a variable polarity. Also, the voltage data may include information with respect to the polarity of the bias voltage.

In an embodiment, the data processing apparatus may judge the kind of the particle after excluding the current data obtained while the polarity of the bias voltage is inverted. With such an arrangement in which inaccurate current data is excluded, this provides improved precision.

A measurement apparatus according to an embodiment is configured such that, in measurement, it is coupled to a data processing apparatus and a nanopore device including a pore and an electrode pair. The measurement apparatus includes: a voltage source structured to apply a bias voltage across the electrode pair of the nanopore device; a transimpedance amplifier structured to detect a current that flows through the electrode pair of the nanopore device in measurement; an A/D conversion block structured to convert an output signal of the transimpedance amplifier into digital current data; and a bus controller coupled to the data processing apparatus, and structured to control the voltage source and the A/D conversion block based on a control command received from the data processing apparatus, and to transmit the current data and the voltage data that indicates the bias voltage applied across the electrode pair to the data processing apparatus in a format that allows them to be associated on a time axis.

### EMBODIMENTS

Description will be made below regarding the embodiments with reference to the drawings. The same or similar components, members, and processes are denoted by the same reference numerals, and redundant description thereof will be omitted as appropriate. The embodiments have been described for exemplary purposes only and are by no means intended to restrict the present disclosure or the present invention. Also, it is not necessarily essential for the present disclosure or the present invention that all the features or a combination thereof be provided as described in the embodiments.

In the present specification, the state represented by the phrase “the member A is coupled to the member B” includes a state in which the member A is indirectly coupled to the member B via another member that does not substantially affect the electric connection between them, or that does not damage the functions or effects of the connection between them, in addition to a state in which they are physically and directly coupled.

Similarly, the state represented by the phrase “the member C is provided between the member A and the member B” includes a state in which the member A is indirectly coupled to the member C, or the member B is indirectly coupled to the member C via another member that does not substantially affect the electric connection between them, or that does not damage the functions or effects of the connection between them, in addition to a state in which they are directly coupled.

### Basic Configuration

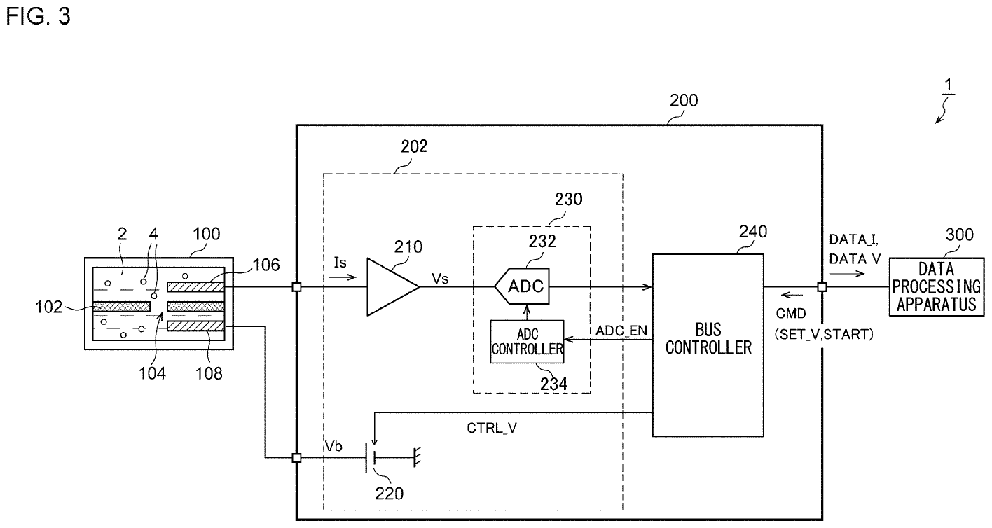

FIG. 3 is a block diagram showing a microparticle measurement system 1 according to an embodiment. The microparticle measurement system 1 includes a nanopore device 100, a measurement apparatus 200, and a data processing apparatus 300.

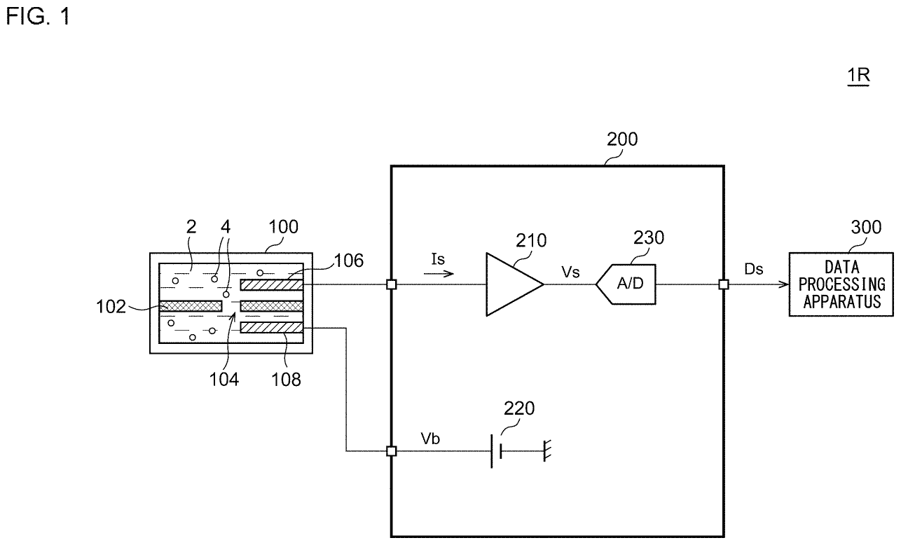

As described with reference to FIG. 1, the nanopore device 100 includes a nanopore chip 102 provided with a pore 104 and an electrode pair 106 and 108. An internal space of the nanopore chip 102 is filled with an electrolyte solution such as a potassium chloride (KCl) solution, phosphate buffered saline (PBS) solution, or the like.

The measurement apparatus 200 is configured to be capable of applying a voltage across the electrode pair 106 and 108, and of measuring a current Is that flows through the pore 104. The measurement apparatus 200 includes a current measurement unit 202 and a bus controller 240.

The current measurement unit 202 is configured to apply a bias voltage Vb that corresponds to a voltage control signal CTRL_V across the electrode pair 106 and 108, and to generate current data DATA_I that corresponds to a current signal Is that flows through the nanopore device 100.

The current measurement unit 202 includes a transimpedance amplifier 210, a voltage source 220, and an A/D conversion block 230. The voltage source 220 is configured as a variable voltage source, and generates a bias voltage Vb having a voltage level/polarity corresponding to the voltage control signal CTRL_V. The transimpedance amplifier 210 converts a current signal Is into a voltage signal Vs. The A/D conversion block 230 converts the voltage signal Vs into digital current data DATA_I.

The bus controller 240 is configured to support bidirectional data transmission with the data processing apparatus 300. The bus controller 240 receives a control command CMD from the data processing apparatus 300. The control command CMD includes a voltage setting command SET_V, a start command START for instructing the measurement apparatus 200 to start measurement, etc. Upon receiving the start command START, the bus controller 240 asserts an enable signal ADC_EN. Furthermore, the bus controller 240 generates the voltage control signal CTRL_V that corresponds to the voltage setting command SET_V so as to control the voltage level and the polarity of the bias voltage Vb to be generated by the voltage source 220.

For example, the voltage source 220 may be configured as a D/A converter. In this case, the voltage control signal CTRL_V is configured as a digital input of the D/A converter.

The A/D conversion block 230 includes an A/D converter 232 and an A/D conversion controller 234. When the enable signal ADC_EN is asserted, the A/D conversion controller 234 supplies a sampling signal SMP to the A/D converter 232 at a predetermined sampling rate so as to quantize and acquire the voltage signal Vs as the current data DATA_I.

Furthermore, the bus controller 240 transmits the current data DATA_I generated by the A/D conversion block 230 to the data processing apparatus 300. Furthermore, the bus controller 240 transmits voltage data DATA_V including information with respect to the waveform of the bias voltage Vb to the data processing apparatus 300.

The data processing apparatus 300 acquires the current data DATA_I and the voltage data DATA_V such that they are associated on the time axis. Furthermore, the data processing apparatus 300 judges the kind of the particles 4 housed in the nanopore device 100.

The data processing apparatus 300 functions as an interface with the user. Furthermore, the data processing apparatus 300 integrally controls the microparticle measurement system 1, and has functions of acquiring, storing, and displaying measurement results. The data processing apparatus 300 may be configured as a general-purpose computer or a workstation. Also, the data processing apparatus 300 may be configured as a dedicated hardware component designed for the microparticle measurement system 1.

The data processing apparatus 300 processes the current data DATA_I and the voltage data DATA_V received from the measurement apparatus 200 and judges the number and size or the kind of the particles 4 included in the electrolyte solution 2. For example, the data processing apparatus 300 may provide particle analysis processing for judging the kind of the particles based on the current data DATA_I and the voltage data DATA_V as the input thereof.

For example, the data processing apparatus 300 is configured as a data processing apparatus such as a laptop computer, desktop computer, tablet terminal, or the like. The functions of the data processing apparatus 300 described in the present specification are supported by a processor (CPU: Central Processing Unit) included in the data processing apparatus and a software program to be executed by the processor.

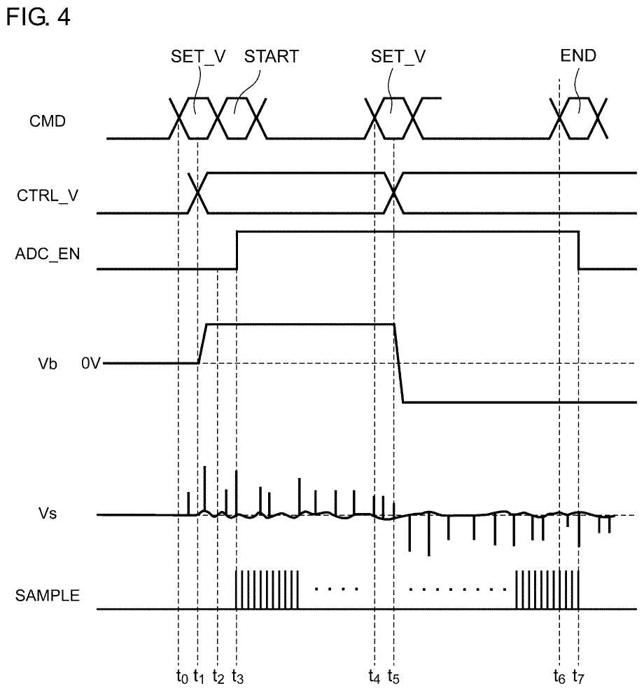

The above is the configuration of the microparticle measurement system 1. Next, description will be made regarding the operation thereof. FIG. 4 is a time chart showing the operation of the microparticle measurement system 1. The data processing apparatus 300 executes a program and issues a command that corresponds to the program. At the time point to, the data processing apparatus 300 issues the voltage setting command SET_V. In response to this, at the time point t₁, the bus controller 240 changes the voltage control signal CTRL_V. As a result, the bias voltage Vb is set to the voltage level and polarity (+0.1 V in this example) specified by the voltage setting command SET_V. In FIG. 4, the voltage signal Vs is measured in an AC coupling state.

Subsequently, at the time point t₂, the data processing apparatus 300 issues a start command START. When the bus controller 240 asserts an enable signal ADC_EN at the time point t₃, a sampling signal SMP is generated at a predetermined sampling rate. In this state, the current signal Is is acquired, and the current data DATA_I is generated.

Furthermore, after the time point t₃, the bus controller 240 generates the voltage data DATA_V every time the current data DATA_I is sampled and transmits the current data DATA_I and the voltage data DATA_V to the data processing apparatus 300. The voltage data DATA_V is preferably configured as the bias voltage Vb actually applied across the electrode pair 106 and 108 at each sampling time point. For example, the bus controller 240 may receive data that indicates the bias voltage Vb from the voltage source 220 and may generate the voltage data DATA_V based on the data thus received. Alternatively, the bus controller 240 may generate the voltage data DATA_V based on the voltage control signal CTRL_V generated by the bus controller 240 itself at each sampling time point.

At the time point t₄, the data processing apparatus 300 issues a voltage setting command SET_V. In response to this, at the time point t₅, the bus controller 240 changes the voltage control signal CTRL_V. As a result, the bias voltage Vb is changed to the voltage level and polarity (−0.1 V in this example) specified by the voltage setting command SET_V. In this state, the measurement apparatus 200 continues measurement.

At the time point t₆, the data processing apparatus 300 issues an end command END. In response to this, at the time point t₇, the bus controller 240 negates the enable signal ADC_EN, which ends the acquisition of the current signal Is.

The above is the operation of the microparticle measurement system 1. With the microparticle measurement system 1, this allows the voltage application conditions to be stored together with the current measurement data. With this, the data processing apparatus 300 is capable of obtaining information with respect to the time point at which the voltage level or the voltage polarity has actually changed. With this, the microparticle measurement system 1 can be used to judge the kind of the particles.

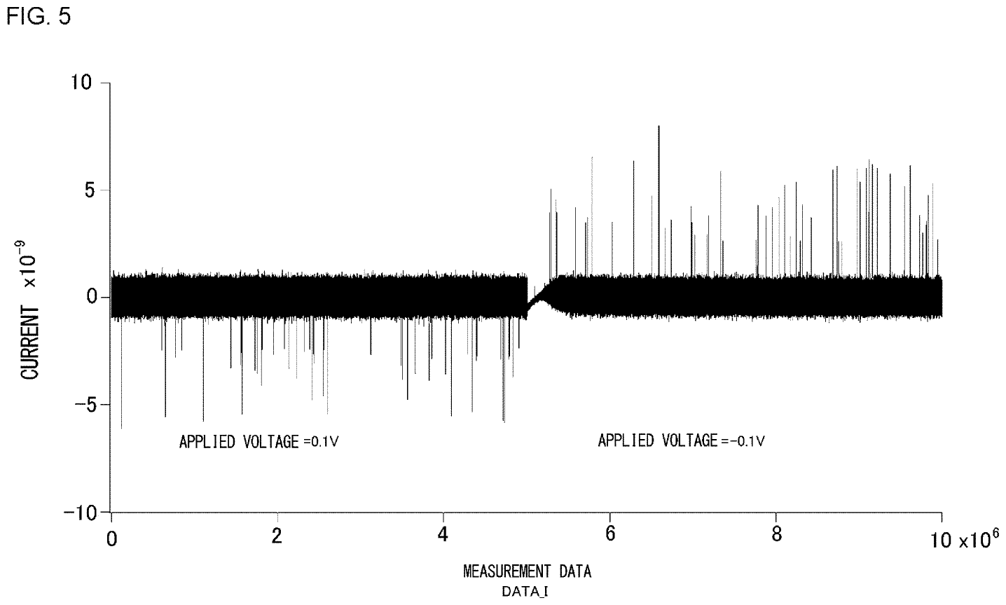

FIG. 5 is a diagram showing an example of the current data measured when the bias voltage Vb is changed. For example, the data processing apparatus 300 detects clogging of the nanopore chip 102 based on the current data DATA_I. With this, upon detecting clogging or a sign thereof, the voltage setting command SET_V is generated in order to invert the polarity of the bias voltage Vb. In other words, immediately before and after the inversion of the voltage polarity, there is a high probability of the occurrence of such clogging. It can be said that the current data DATA_I acquired in this state has poor reliability. In order to solve such a problem, after the data processing apparatus 300 excludes the current data acquired when the polarity of the bias voltage Vb has been inverted, the data processing apparatus 300 judges the kind of the particles. This allows inaccurate current data to be excluded, thereby providing improved judgment precision.

The above-described embodiment has been described for exemplary purposes only and is by no means intended to be interpreted restrictively. Rather, it can be readily conceived by those skilled in this art that various modifications may be made by making various combinations of the above-described components or processes, which are also encompassed in the technical scope of the present invention. Description will be made below regarding such modifications.

### First Modification

Description has been made in the embodiment regarding an arrangement in which the voltage data DATA_V is generated at the same rate as the current data DATA_I. However, the present invention is not restricted to such an arrangement. Also, the voltage data DATA_V may be generated every time the voltage application conditions are changed. This allows the amount of data to be transmitted from the measurement apparatus 200 to the data processing apparatus 300 to be reduced. For example, in the example shown in FIG. 4, the voltage data DATA_V that indicates the voltage application conditions may be generated at the time points t₁ and t₅.

### Second Modification

When only the polarity of the bias voltage Vb is inverted while the voltage level thereof is maintained at a constant level, only the polarity information may be stored as the voltage data DATA_V. This allows the data amount of the voltage data DATA_V to be reduced.

### Third Modification

Description has been made in the embodiment regarding an arrangement in which the voltage data DATA_V is transmitted from the bus controller 240 to the data processing apparatus 300. However, the present invention is not restricted to such an arrangement. Also, the voltage data DATA_V may be generated by the data processing apparatus 300. In a case in which there is a short delay time between the issuance of the voltage setting command SET_V and the actual change in the application conditions of the bias voltage Vb, the voltage data can be generated assuming that the time point at which the voltage setting command SET_V is issued is the same as the time point at which the voltage application conditions are changed.

The above-described embodiments show only an aspect of the mechanisms and applications of the present invention. Rather, various modifications and various changes in the layout can be made without departing from the spirit and scope of the present invention defined in appended claims.

What is claimed is:

1. A microparticle measurement system comprising:
a nanopore device including a pore and an electrode pair, a current measurement unit structured to apply a bias voltage that corresponds to a voltage setting command across the electrode pair, and to generate digital current data that corresponds to a current signal that flows through the nanopore device; and
a data processing apparatus structured to generate the voltage setting command, to acquire the current data and voltage data including information with respect to a waveform of the bias voltage in a form in which they are associated on a time axis, and to judge a kind of a particle stored in the nanopore device based on the current data and the voltage data.

2. The microparticle measurement system according to claim 1, wherein the voltage data is generated at the same rate as a sampling rate of the current data.

3. The microparticle measurement system according to claim 1, wherein the voltage data is generated every time a voltage application condition of the bias voltage is changed.

4. The microparticle measurement system according to claim 3, wherein the current measurement unit comprises a voltage source structured to generate the bias voltage that corresponds to a voltage control signal,
and wherein the voltage data is generated every time a state of the voltage source is switched.

5. The microparticle measurement system according to claim 3, wherein the voltage data is generated every time the data processing apparatus issues the voltage setting command.

6. The microparticle measurement system according to claim 1, wherein the bias voltage has a variable voltage level,
and wherein the voltage data includes information with respect to a voltage level of the bias voltage.

7. The microparticle measurement system according to claim 1, wherein the bias voltage has a variable polarity,
and wherein the voltage data includes information with respect to the polarity of the bias voltage.

8. The microparticle measurement system according to claim 7, wherein the data processing apparatus judges a kind of the particle after excluding the current data obtained when the polarity of the bias voltage is inverted.

9. A measurement apparatus structured such that, in measurement, it is coupled to a data processing apparatus and a nanopore device comprising a pore and an electrode pair, the measurement apparatus comprising:
a voltage source structured to apply a bias voltage across the electrode pair of the nanopore device,
a transimpedance amplifier structured to detect a current that flows through the electrode pair of the nanopore device in measurement,
an A/D conversion block structured to convert an output signal of the transimpedance amplifier into digital current data; and
a bus controller coupled to the data processing apparatus and structured to control the voltage source and the A/D conversion block based on a control command received from the data processing apparatus, and to transmit the current data and the voltage data that indicates the bias voltage applied across the electrode pair to the data processing apparatus in a format that allows them to be associated on a time axis.
